(19) United States
(12) Patent Application Publication
(10) Pub. No.: US 2023/0073732 A1
(43) Pub. Date: Mar. 9, 2023

(54) COMPOSITIONS OF BATTERS FOR PREPARING AN EDIBLE MULTILAYER FOOD CARRIER

(71) Applicant: Crunch Food, Inc., San Francisco, CA (US)

(72) Inventors: DeWolf Emery, San Francisco, CA (US); Brogan Miller, San Francisco, CA (US); Zal Taleyarkhan, San Francisco, CA (US); Tiffany Swan, San Francisco, CA (US)

(21) Appl. No.: 17/942,010

(22) Filed: Sep. 9, 2022

Related U.S. Application Data
(60) Provisional application No. 63/242,300, filed on Sep. 9, 2021.

(51) Int. Cl. A23L 19/12; A21D 10/04; A21D 2/18; A21D 2/02

(52) U.S. Cl. CPC A23L 19/12; A21D 10/04; A21D 2/186; A21D 2/02

(57) ABSTRACT

One variation of a multilayer edible food carrier includes a brittle edible layer formed of a first batter comprising: a volume of a base mixture including water, salt, grain flour, fat, and lecithin; a volume of gas dispersed throughout the volume of the base mixture; and a volume of oil absorbed by the first batter within a cook chamber configured to transform the first batter into the brittle edible layer. The multilayer edible food carrier further includes a soft edible layer: nested within the brittle edible layer in an assembled configuration; and formed of a second batter comprising water, a fat blend comprising cheese dissolved in water, an amount of grain flour, an amount of starches, an amount of baking powder, an amount of an emulsifying agent, an amount of dairy milk, an amount of fat, an amount of sweeteners, and an amount of flavoring agents.

### CROSS-REFERENCE TO RELATED APPLICATIONS

This application claims the benefit of U.S. Provisional Patent Application No. 63/242,300, filed on 9 Sep. 2021, which is incorporated in its entirety by this reference.

This application is related to U.S. patent application Ser. No. 17/485,183, filed on 24 Sep. 2021, which is a continuation application of U.S. patent application Ser. No. 17/316,404, filed on 10 May 2021, which claims the benefit of U.S. Provisional Patent Application No. 63/022,045, filed on 8 May 2020, each of which is incorporated in its entirety by this reference.

### TECHNICAL FIELD

This invention relates generally to the field of food science and more specifically to a new and useful batter composition for preparing a multilayer edible food carrier in the field of food science.

### BRIEF DESCRIPTION OF THE FIGURES

FIG. 1 is a schematic representation of an edible food carrier;

FIGS. 2A and 2B are schematic representations of the edible food carrier;

FIG. 3 is a schematic representation of the edible food carrier;

FIGS. 4A and 4B are schematic representations of a first batter;

FIGS. 5A, 5B, and 5C are schematic representations of a second batter; and

FIG. 6 is a schematic representation of an edible adhesive.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Edible Food Carrier

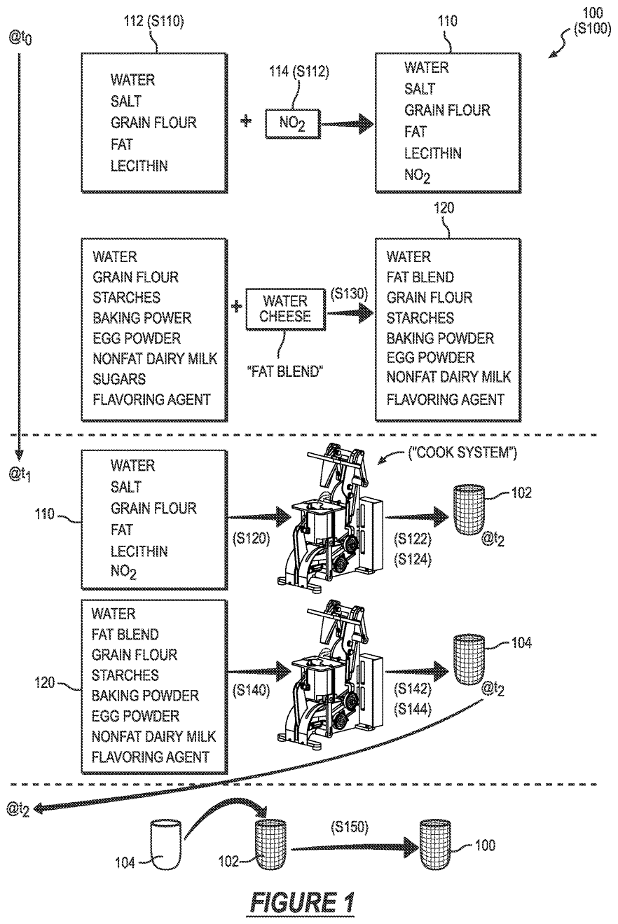

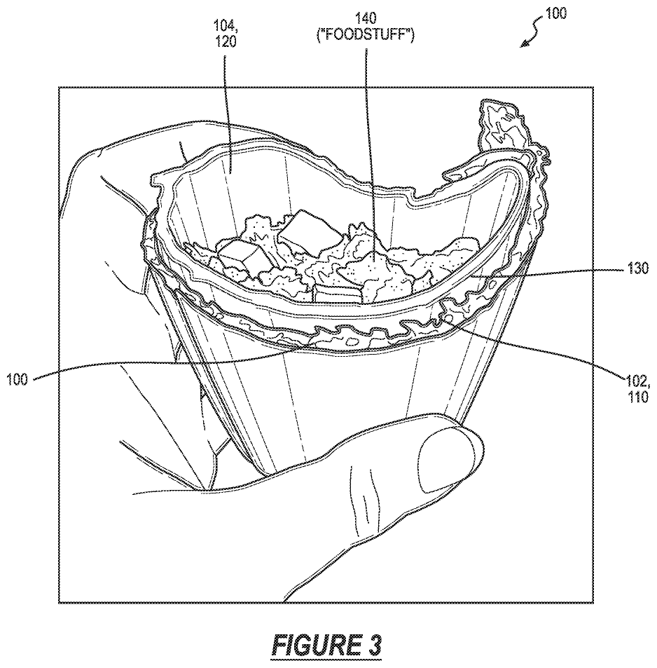

As shown in FIGS. 1, 2A, 2B, and 3, an edible food carrier 100 includes: a brittle edible layer 102 formed of a first batter 110; and a soft edible layer 104 configured to nest within the brittle edible layer 102 in an assembled configuration and formed of a second batter 120.

The first batter 110 includes a volume of a base mixture 112 including: a first amount of water; a second amount of salt; a third amount of grain flour defining a ratio of pregelatinized flour to raw flour corresponding to a target texture defined for the brittle edible layer 102; a fourth amount of fat corresponding to a target flavor profile defined for the brittle edible layer 102; a fifth amount of lecithin defining a concentration within a target concentration range corresponding to a target surface finish defined for the brittle edible layer 102; and a sixth amount of potato (e.g., pregelatinized potato). The first batter 110 further includes: a volume of a gas dispersed throughout the volume of the base mixture 112 and configured to cooperate with the base mixture 112 to form a liquid-gas suspension; and an amount of oil 116—absorbed by the liquid-gas suspension within a cook chamber configured to transform the first batter no into the brittle edible layer 102—configured to cooperate with the fifth amount of lecithin to regulate release of the brittle edible layer 102 from the cook chamber.

The second batter 120 includes: a sixth amount of water; a seventh amount of a fat blend comprising cheese dissolved in water; an eighth amount of grain flour; a ninth amount of starches; a tenth amount of baking powder; an eleventh amount of an emulsifying agent; a twelfth amount of dairy milk; a thirteenth amount of fat; a fourteenth amount of sweeteners; and a fifteenth amount of flavoring agents.

In one variation, the soft edible layer 104 and the brittle edible layer 102 cooperate to form an internal volume in the assembled configuration. In this variation, the multilayer edible food carrier 100 further includes a set of edible fillings 140 (e.g., salad fillings, taco fillings, gyro fillings) corresponding to a food product type and loaded within the internal volume.

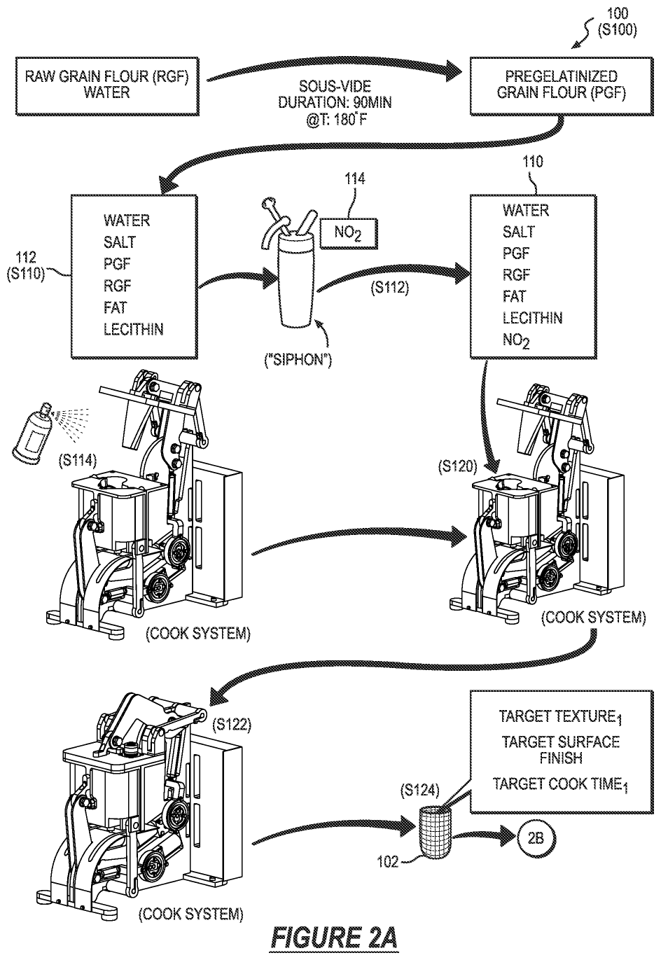

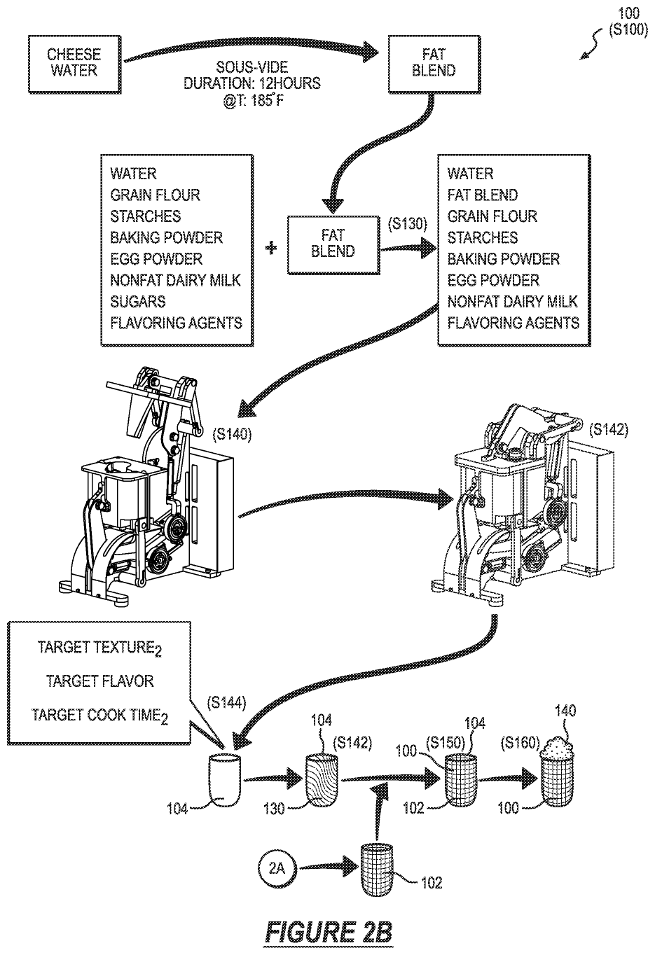

In one variation, as shown in FIGS. 2B, 3, and 6, the multilayer edible food carrier 100 further includes an edible adhesive 130: applied to an outer surface of the soft edible layer 104 in a preassembled configuration; configured to promote adhesion between the outer surface of the soft edible layer 104 and an inner surface of the brittle edible layer 102 in the assembled configuration; and including a homogenous mixture of water, starch, grain flour, salt, milk, and flavorings.

One variation of the edible food carrier 100 includes a brittle edible layer 102: configured to exhibit a first target texture and a first target cook time; and formed of a first batter 110, cooked within a first cook chamber to form the brittle edible layer, and including an amount of water, an amount of salt, an amount of grain flour, an amount of potato, an amount of fat, an amount of a release agent, and an amount of nitrous oxide. In this variation, the edible food carrier 100 further includes a soft edible layer 104: configured to exhibit a second target texture distinct from the first target texture, exhibit a second target cook time within a threshold deviation of the first target cook time, exhibit a target flavor profile, and nest within the brittle edible layer 102 in an assembled configuration to form an inner volume configured to receive a set of edible fillings; and formed of a second batter 120, cooked within a second cook chamber to form the soft edible layer 104, the second batter 120 including water, fat, grain flour, starches, baking powder, an emulsifying agent, dairy milk, sweeteners, and flavoring agents.

### 1.1 Brittle-Type Batter

As shown in FIGS. 1, 2A, 4A and 4B, the first batter 110 (hereinafter the “brittle-type batter” 110) is configured to form a brittle edible layer 102 exhibiting a first set of target characteristics comprising: a first target texture; a first target surface finish (e.g., characterized by browning, uniformity); a first target cook time within a cook chamber configured to transform the brittle-type batter 110 into the brittle edible layer 102; and a first target quick release (e.g., characterized by a degree of sticking of the brittle edible layer 102 to surfaces of the cook chamber) from the cook chamber. The brittle-type batter 110 includes a first set of ingredients including: an amount of water (e.g., distilled water); an amount of salt; an amount of grain flour (e.g., rice flour); an amount of fat (e.g., ghee); an amount of potato (e.g., pregelatinized potato); an amount of lecithin (e.g., sunflower lecithin); and an amount of gas 114 (e.g., nitrous oxide).

In one variation, the brittle-type batter no further includes an amount of oil 116 (e.g., flaxseed oil) absorbed by the brittle-type batter no within the cook chamber.

One variation of the brittle-type batter no includes a base mixture 112 including: an amount of water; an amount of salt; an amount of grain flour defining a ratio of pregelatinized flour to raw flour corresponding to a first target texture defined for the brittle edible layer 102; an amount of fat corresponding to a first target flavor profile defined for the brittle edible layer 102; an amount of potato corresponding to the first target flavor profile; and an amount of lecithin corresponding to a first target surface finish defined for the brittle edible layer 102. In this variation, the brittle-type batter no further includes: a volume of gas 114 dispersed throughout the volume of the base mixture 112 and configured to cooperate with the base mixture 112 to form a liquid-gas suspension; and an amount of oil 116 absorbed by the liquid-gas suspension within a cook chamber configured to transform the brittle-type batter no into the brittle edible layer 102 and configured to cooperate with the amount of lecithin to regulate release of the brittle edible layer 102 from the cook chamber.

### 1.2 Soft-Type Batter

As shown in FIGS. 1, 2B, 5A, 5B, and 5C, the second batter 120 (hereinafter the “soft-type batter” 120) is configured to form a soft edible layer 104 exhibiting a second set of target characteristics comprising: a second target texture distinct from the first target texture exhibited by the brittle edible layer 102; a second target cook time within a threshold deviation of the first target cook time exhibited by the brittle edible layer 102; and a second flavor profile. The soft-type batter 120 includes a second set of ingredients including: an amount of water (e.g., distilled water); an amount of fats (e.g., canola oil, cheese); an amount of grain flour (e.g., rice flour); an amount of starches (e.g., corn starches, potato starches); an amount of baking powder; an amount of an emulsifier (e.g., egg products); an amount of milk (e.g., nonfat dairy milk); an amount of sweeteners (e.g., inulin); and an amount of flavoring agents (e.g., lemon oil).

### 2. Method

As shown in FIGS. 1, 2A, and 2B, a method S100 includes, during a first preparation period: mixing a first set of ingredients to generate a base mixture 112, the first set of ingredients including a first amount of water, a first amount of salt, a first amount of grain flour, a first amount of fats, and a first amount of lecithin in Block Silo; and pressurizing the base mixture 112 with a volume of nitrous oxide to generate a first batter 110 including nitrous oxide dispersed throughout the base mixture 112 (e.g., in a liquid-gas suspension) in Block S112. The method S100 further includes, during a first cook period succeeding the first preparation period: applying oil to surfaces of a first cook chamber in Block S114; loading a volume of the first batter 110 into the first cook chamber in Block S120; cooking (e.g., via heating of) the volume of the first batter 110 within the first cook chamber, according to a first cook cycle of a first target duration, to transform the volume of the first batter 110 into a brittle edible layer 102 in Block S122; and, in response to expiration of the first target duration, removing the brittle edible layer 102 from the first cook chamber in Block S124.

The method S100 further includes: during a second preparation period, mixing a second set of ingredients to generate a second batter 120, the second set of ingredients including a second amount of water, a second amount of fats, a second amount of grain flour, an amount of starches, an amount of baking powder, an amount of an emulsifying agent, an amount of sweeteners, and an amount of flavoring agents in Block S130; and, during a second cook period succeeding the second preparation period, loading a volume of the second batter 120 into a second cook chamber in Block S140, cooking (e.g., via heating of) the volume of the second batter 120 within the second cook chamber, according to a second cook cycle of a second target duration, to transform the volume of the second batter 120 into a soft edible layer 104 in Block S142, and, in response to expiration of the second target duration, removing the soft edible layer 104 from the second cook chamber in Block S144. During an assembly period succeeding the first cook period and the second cook period, the method S100 further includes nesting the soft edible layer 104 within the brittle edible layer 102 to form a multilayer edible carrier 100 configured for loading with edible fillings 140 in Block S150.

In one variation, the method S100 further includes, during the assembly period, loading a set of fillings 140 into the multilayer edible carrier 100 to assemble a foodstuff in Block S160.

In one variation, the method S100 further includes, during the assembly period, applying an edible adhesive 130 to an outer surface of the soft edible layer 104, the edible adhesive 130 configured to promote adhesion between the outer surface of the soft edible layer 104 and an inner surface of the brittle edible layer 102 in Block S142. In this variation, Block S150 of the method S100 includes nesting the soft edible layer 104—including the edible adhesive 130 applied to the outer surface—within the brittle edible layer 102 to form the multilayer edible carrier 100 configured for loading with edible fillings 140.

### 3. Applications

Generally, a set of ingredients can be mixed to form a volume of batter that can be cooked (e.g., via surface frying) within a cook chamber (e.g., a set of mold components) to form an edible, thin-shell food carrier 100 (or “multilayer edible carrier” 100).

In particular, a first set of ingredients can be mixed to form a brittle-type batter no that can be processed further—according to various food processing techniques and/or in combination with additional ingredients—and cooked (e.g., via surface frying) within a first cook chamber (e.g., a first set of mold components) to form a brittle edible layer or “shell” 102 (hereinafter a “brittle outer shell” 102). Further, a second set of ingredients can be mixed to form a soft-type batter 120 that can be processed further—according to various food processing techniques and/or in combination with additional ingredients—and cooked within a second cook chamber (e.g., a second set of mold components) to form a soft edible layer or “shell” 104 (hereinafter a “soft inner shell” 104). Once cooked, the soft inner shell 104 can be inserted into the brittle outer shell 102 to form the multilayer, edible food carrier 100 that exhibits: both brittle and soft characteristics; and sufficient structural integrity to hold a filling (e.g., salads, sauces, meat products, toppings) for a duration of a meal.

As shown in FIGS. 1, 2A, 4A, and 4B, the brittle-type batter 110 can include: water, salt, grain flour (e.g., raw rice flour and/or pregelatinized rice flour), fat (e.g., ghee), an emulsifying agent (e.g., lecithin), and/or gas (e.g., nitrous oxide). These ingredients can be combined in a particular order and at particular concentrations to form the brittle-type batter 110, which can then be cooked (e.g., via surface frying within a brittle-type cooking mold) according to a brittle-type cook cycle to form a brittle (or “crunchy,” “crispy”) outer shell that: exhibits crispy textural characteristics (e.g., a glassy, brittle, fried-like or brûlée-like texture that shatters when chewed); exhibits a browned (e.g., via Maillard reactions), glossy, and smooth finish (e.g., on surfaces of the inner shell 104); releases from the brittle-type cooking mold without sticking to the mold or breaking when removed; and completes cooking with a target cook range (e.g., between 90 seconds and 400 seconds).

The soft-type batter 120 can include: water, a fat blend (e.g., a homogenous mixture of cheese and water), grain flour (e.g., glutinous rice flour), starches (e.g., potato starch, corn starch), baking powder, egg products (e.g., egg powder), dairy milk (e.g., nonfat dairy milk), additional fats (e.g., ghee), sugars (e.g., chicory root fiber), and/or flavoring agents (e.g., lemon oil). These ingredients can also be combined in a particular order and at particular concentrations to form the soft-type batter 120, which can then be cooked (e.g., via baked within a soft-type cooking mold) according to a soft-type cook cycle to form a soft (or “chewy”) outer shell that: exhibits soft textural characteristics (e.g., a texture analogous to or perceived as mochi, undercooked brioche bread, a browned durable crepe, or a flexible cracker when chewed); exhibits flavors matched to a particular type of food (e.g., savory or sweet, a specific type of cuisine) loaded into the multilayer, edible food carrier 100; releases from the soft-type cooking mold without sticking to the mold or tearing when removed; and completes cooking within the target cook range (e.g., between 60 seconds and 150 seconds), such that the brittle outer shell 102 and the soft inner shell 104 are both completely cooked and ready for assembling the multilayer edible food carrier 100 within this target cook range.

The resulting soft inner shell 104 can then be inserted into the resulting brittle outer shell 102 to form the multilayer edible food carrier 100, as shown in FIGS. 1 and 2B. Once combined: the brittle outer shell 102 can provide structure to the multilayer edible food carrier 100, thereby enabling a user to hold and consume the multilayer edible food carrier 100 and its contents; and the soft inner shell 104 can support the brittle outer shell 102, prevent moisture migration from fillings (e.g., salads, sauces, meat products, toppings) to the brittle outer shell 102, extend the plate life of the brittle outer shell 102, and retain pieces of the brittle outer shell 102 together as the brittle outer shell 102 cracks during consumption. Thus, the brittle outer shell 102 and the soft inner shell 104 can fuse to form a shell with: crispy, crunchy textural characteristics; soft, chewy internal characteristics; and structural integrity over time as the multilayer edible food and its contents are consumed.

### 3.1 Applications: Experience

Once the multilayer edible carrier 100 is assembled, an operator (e.g., food handler) may load various fillings 140 and toppings into the internal volume formed by the multilayer edible carrier 100, such as salad fillings, taco fillings, meatball marinara fillings, or any other sweet and/or savory fillings.

The multilayer edible carrier 100 may then be served to a customer, such as in the form of a meal or snack. The customer may then hold the structurally-stable multilayer edible carrier 100 in one hand and bite into the multilayer edible carrier 100 and its fillings 140. The brittle outer layer of the multilayer edible carrier 100 may then break around the customer's bite and shatter in the user's mouth as she chews, thereby producing a crispy and satisfying initial mouthfeel. Concurrently, the soft inner shell 104 may tear around the user's bite and produce a soft, pillowy (or “chewy”) mouthfeel behind the crispy mouthfeel of the brittle outer shell 102. The user may then taste the fillings 140, all of which result in a dynamic textural experience overlayed on flavors of the brittle outer shell 102 (e.g., salty, potato-flavored), the soft inner shell 104 (e.g., sweet, rich, and/or parmesan-flavored), and the fillings 140 (e.g., primary meal flavors). Furthermore, as the customer continues to consume the multilayer edible carrier 100 and its fillings 140, the soft inner shell 104 continues to prevent diffusion of liquid from the fillings 140 toward the brittle outer shell 102 such that the multilayer edible carrier 100 maintains both its structure and its mouthfeel (or “crispiness”) throughout the duration of the meal.

### 4. Cook System

As described in U.S. patent application Ser. No. 17/316,404—filed on 10 May 2021, which is incorporated in its entirety by this reference—a cook system (e.g., a cook system) for preparing a multilayer edible food carrier 100 can include: a set of mold components (i.e., the cook chamber) that cooperate to define a thin-shell cavity in a cook configuration/closed position; and a set of heating elements that heat this set of mold components to transform a volume of batter—occupying this thin-shell cavity—into an edible thin-shell carrier. Once this edible thin-shell carrier is cooked within the thin-shell cavity, these mold components open to release the edible thin-shell carrier. Furthermore, two instances of the cook system can be operated in conjunction to concurrently: cook a volume of the soft-type batter 120 into a soft inner shell 104; and cook a volume of the brittle-type batter no into a brittle outer shell 102.

For example, a first instance of the cook system can include: a first set of mold components defining a first thin-shell cavity geometry in the closed position; and a first controller that executes a first cook cycle tuned to the soft-type batter 120 to produce the soft inner shell 104. In this example, a second instance of the cook system can include: a second set of mold components defining a second thin-shell cavity geometry—similar to and outwardly offset from the first thin-shell cavity geometry—in the cook configuration; and a second controller (or the first controller) that executes a second cook cycle tuned to the brittle-type batter no to produce the brittle outer shell 102, which can then be assembled with the soft inner shell 104 to form the multilayer edible food carrier 100, as shown in FIGS. 1 and 2B.

Thus, instances of the cook system can cooperate to transform a set of (e.g., two) distinct batters into a set of (e.g., two) nested edible shells of different characteristic textures, which can then be assembled into a multilayer edible food carrier 100 and filled with various fillings 140.

### 5. Brittle-Type Batter

As shown in FIGS. 1, 2A, 4A, and 4B, the brittle-type batter 110 can include a first set of ingredients including: an amount of water; an amount of salt; an amount of grain flour (e.g., raw rice flour and/or pregelatinized rice flour); an amount of fat (e.g., ghee); an amount of a release agent (e.g., lecithin); an amount of potato (e.g., pregelatinized potato); and/or a volume of gas 114 (e.g., nitrous oxide). The first set of ingredients can be combined in a particular order and at particular concentrations such that, when cooked (e.g., via surface frying), the resulting brittle outer shell 102 exhibits a first set of target characteristics, such as: a crispy texture (e.g., a glassy, brittle, fried-like or brûlée-like texture that shatters when chewed); a particular degree of surface browning (e.g., due to Maillard reactions); a uniform (e.g., smooth, even, consistent) outer surface (e.g., opposite the soft inner shell 104); a finished cook time within a particular brittle-type cook time range (e.g., between 90 seconds and 400 seconds); and/or a quick-release (e.g., with no breakage or sticking) from a brittle-type cook mold when fully cooked.

### 5.1 Brittle-Type Batter: Ingredients

In one implementation, the brittle-type batter 110 includes the first set of ingredients including: a volume of water; an amount of salt; an amount of grain flour including a mixture of raw grain flour and pregelatinized grain flour; an amount of fat; an amount of potato (e.g., pregelatinized potato); an amount of a release agent; and a volume of gas 114. In this implementation, the water, salt, lecithin, grain flour, and fat can be mixed with the gas (e.g., in a whipping siphon) to form a liquid-gas suspension. This liquid-gas suspension can be: stored under pressure (e.g., in a whipping siphon); and then injected into a cook chamber to generate the brittle outer shell 102.

Additionally, in the preceding implementation, the brittle-type batter 110 can further include: an amount of starches (e.g., potato starches); an amount of milk (e.g., non-fat dairy milk); and/or an amount of flavorings. For example, the brittle-type batter 110 can include a first set of ingredients including: an amount of distilled water; an amount of kosher salt; an amount of sunflower lecithin (e.g., powdered sunflower lecithin); an amount of rice flour (e.g., glutinous rice flour) including a mixture of raw rice flour and pregelatinized rice flour; an amount of ghee; an amount of potato; an amount of lecithin; a volume of nitrous oxide; an amount of milk (e.g., nonfat dry milk powder); and/or an amount of potato flavoring.

In each of these implementations, this first set of ingredients can be combined in a particular order and in particular amounts (e.g., at particular concentrations, proportions, masses, quantities) to form the brittle-type batter 110. This brittle-type batter 110 can then be cooked in a cook chamber—according to a predefined cook cycle—to generate the brittle outer shell 102 exhibiting a target set of characteristics—such as a target texture, target surface finish, target release, target flavor profile, and/or target cook time—defined for the brittle outer shell 102.

In particular, the brittle-type batter no can include: a base mixture 112 including an amount of water, an amount of salt, an amount of grain flour, an amount of fat, an amount of potato, and an amount of lecithin; a volume of gas 114 dispersed throughout the base mixture 112 and configured to cooperate with the base mixture 112 to form a liquid-gas suspension; and/or an amount of oil 116 (e.g., flaxseed oil) absorbed by the liquid-gas suspension within a cook chamber configured to transform the brittle-type batter no into the brittle outer shell 102.

The base mixture 112 can be mixed to include varying concentrations of the set of ingredients based on a target set of characteristics defined for the resulting brittle outer shell 102. In one implementation, the base mixture 112 can be mixed to include a set of ingredients including: a concentration of water between 35 percent and 45 percent by weight; a concentration of salt between 0.20 percent and 1 percent by weight; a concentration of raw grain flour between 5 percent and 15 percent by weight; a concentration of pregelatinized grain flour between 5 percent and 20 percent by weight; a concentration of fats between 5 percent and 15 percent by weight; a concentration of potato (e.g., pregelatinized potato) between 20 percent and 30 percent by weight; and a concentration of lecithin between zero percent and 0.40 percent by weight.

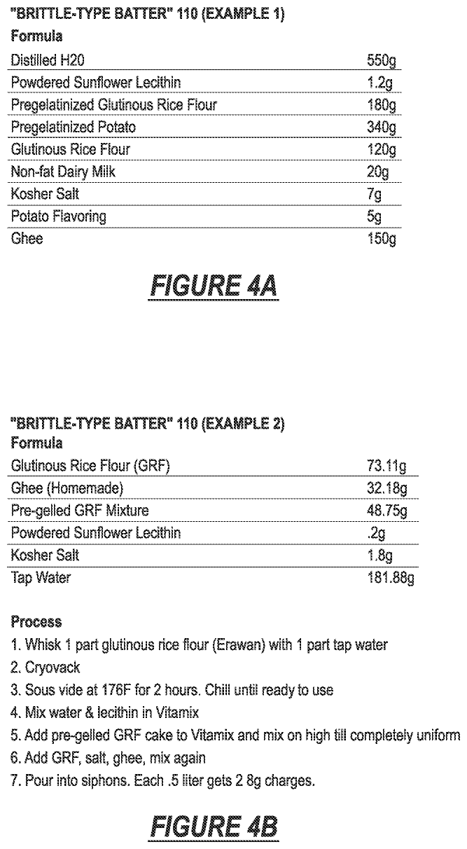

In one example, as shown in FIG. 4A, the base mixture 112 can include: a concentration of water of approximately (e.g., within one percent) 40 percent by weight; a concentration of salt of approximately 0.50 percent by weight; a concentration of raw grain flour of approximately 8.7 percent by weight; a concentration of pregelatinized grain flour of approximately 13 percent by weight; a concentration of fats of approximately 11 percent by weight; a concentration of lecithin of approximately 0.08 percent by weight; a concentration of a potato blend (e.g., pregelatinized potato)—including a mixture of water and potato flakes—of approximately 25 percent by weight; a concentration of milk powder (e.g., nonfat dried milk powder) of approximately 1.4 percent by weight; and a concentration of flavorings (e.g., potato flavorings) of approximately 0.35 percent by weight.

### 5.2 Brittle-Type Batter: Preparation & Cooking

In one implementation, the brittle-type batter 110 can include: an amount of water; an amount of salt; an amount of grain flour defining a ratio of pregelatinized flour to raw flour; an amount of fat; an amount of lecithin; and an amount of a gas 114 (e.g., nitrous oxide).

In this implementation, the brittle-type batter 110 can include a volume of a base mixture 112 including a first set of ingredients including: an amount of water; an amount of salt; an amount of grain flour; an amount of fat; and an amount of lecithin; and a volume of a gas dispersed throughout the volume of the base mixture 112, thereby forming a liquid-gas suspension. Additionally, the brittle-type batter 110 can include an amount of an oil 116 (e.g., flaxseed oil, canola oil)—applied to surfaces of the cook chamber configured to transform the brittle-type batter no into the brittle outer shell 102—absorbed by the liquid-gas suspension during loading and/or cooking within the cook chamber.

In particular, during a first preparation period for the brittle-type batter no, the first set of ingredients—including an amount of water, an amount of salt, an amount of grain flour defining a ratio of pregelatinized grain flour to raw grain flour, an amount of fat, an amount of lecithin, and/or amounts of additional ingredients—such as an amount of starches (e.g., potato starches), an amount of milk, and/or an amount of flavorings—can be mixed in a particular order to form the base mixture 112.

The amount of grain flour, in the first set of ingredients, can be configured to include: an amount of pregelatinized grain flour, such as formed via sous viding of a mixture of water and raw grain flour at a set temperature for a set duration; and an amount of raw grain flour. For example, to generate the pregelatinized flour, an amount of water can be mixed with an amount of raw grain flour to generate a grain-water mixture. This grain-water mixture can then be sous vided at a set temperature—such as within a temperature range of 170 degrees to 190 degrees-Fahrenheit—and for a set duration—such as within a duration range of 60 minutes to 120 minutes—to generate the mixture of pregelatinized grain flour. Then, the first set of ingredients—including an amount of the pregelatinized grain flour and an amount of raw grain flour—can be mixed in a particular order to form the base mixture 112. Finally, the base mixture 112 can be pressurized (e.g., within a whipping siphon) with an amount of a gas 114 (e.g., nitrous oxide) to generate the brittle-type batter 110.

Then, in this implementation, during this first preparation period, a volume of gas 114 (e.g., nitrous oxide) can be mixed throughout the base mixture 112 to form a liquid-gas suspension including the volume of gas 114 dispersed (e.g., uniformly dispersed) throughout the volume of the base mixture 112. In particular, the volume of the base mixture 112 can be pressurized (e.g., within a whipping siphon) with the volume of gas 114 to generate a volume of the brittle-type batter no defining a liquid-gas suspension of gas dispersed throughout the base mixture 112.

Finally, in the preceding implementation, during a first cook period succeeding the first preparation period: an amount (e.g., a volume, mass, proportion, concentration) of oil (e.g., a flaxseed oil, a canola oil) can be applied to surfaces of the first cook chamber configured to transform the volume of the brittle-type batter no into the brittle outer shell 102; the volume of the brittle-type batter 110 can be loaded into the first cook chamber, thereby absorbing oil from surfaces of the first cook chamber (e.g., into the brittle-type batter 110); and the brittle-type batter 110 can be cooked (e.g., via heating) within the first cook chamber—according to a first cook cycle of a first target duration—to transform the volume of the brittle-type batter 110 into the brittle outer shell 102. For example, the first cook cycle can define: the first target duration between 90 seconds and 400 seconds; and a first target temperature between 300 degrees Fahrenheit and 400 degrees Fahrenheit. The brittle-type batter 110 can therefore be cooked within the first cook chamber at the first target temperature and over the first target duration to generate the brittle outer shell 102.

For example, at a first time during a first preparation period for the brittle-type batter 110, the grain-water mixture can be mixed to define a ratio of raw grain flour to water of approximately one (e.g., within 5 percent). In this example, the grain-water mixture can then be sous vided at a set temperature of approximately 180 degrees (e.g., within 5 percent) for a set duration of approximately 90 minutes (e.g., within 5 percent) to generate an amount of the pregelatinized flour. This amount of the pregelatinized flour can then be stored—such as within a refrigerator or any chilled environment—until mixing of the base mixture 112—including an amount of this pregelatinized grain flour and an amount of raw grain flour—defining a particular ratio of pregelatinized grain flour to raw grain flour within a target ratio range (e.g., between 1 and 2).

Additionally, in this example, at a second time during the first preparation period, a potato blend (e.g., pregelatinized potato)—including the amount of potato—can be generated. In particular, in this example, an amount of water can be mixed with an amount of potato flakes—the amount of water exceeding the amount of potato flakes—to generate a starch-water mixture exhibiting a particular ratio of amount of water to amount of potato (e.g., a two to one ratio of amount of water to amount of potato). This starch water-mixture can then be sous vided for a set duration (e.g., 90 minutes)—such as between 60 minutes and 120 minutes—at a target temperature (e.g., 180 degrees Fahrenheit)—such as between 170 degrees Fahrenheit and 190 degrees Fahrenheit—to generate an amount of the starch blend.

Then, in the preceding example, at a third time succeeding the first and second time during the first preparation period: an amount of water can be mixed (e.g., within a blender) with an amount of lecithin to form a first mixture; an amount of the pregelatinized grain flour can be mixed into the first mixture—such as at high shear and for a set duration—to generate a second mixture (e.g., a homogenous second mixture); an amount of raw grain flour, an amount of salt, an amount of fat (e.g., ghee), and an amount of the starch blend can be mixed into the second mixture—such as at high shear and for a set duration—to generate a homogenous base mixture 112 defining a ratio of the first amount of the pregelatinized grain flour to the second amount of raw grain flour of 1.5. A volume of the resulting base mixture 112 can then be: loaded into a siphon (e.g., a whipping siphon); and pressurized with a volume of nitrous oxide—such as via a sequence of charges (e.g., 2 charges, 3 charges, 5 charges) of the siphon, each charge dispersing a set amount of nitrous oxide into the base mixture 112—to generate the brittle-type batter 110 including nitrous oxide dispersed (e.g., uniformly dispersed) throughout the volume of the base mixture 112.

Then, in the preceding example, during a first cook period succeeding the first preparation period, an amount of oil 116 (e.g., flaxseed oil) can be applied to surfaces of the cook chamber, such as by dabbing oil onto surfaces of the cook chamber. Additionally and/or alternatively, an amount of baking spray—such as including flour and oil (e.g., canola oil)—can be applied to surfaces of the cook chamber after application of the amount of oil 116. Then, a volume of the brittle-type batter no can be loaded into the first cook chamber and cooked within the first cook chamber—according to a first cook cycle—to transform the volume of the brittle-type batter no into the brittle outer shell 102. In this example, the first cook cycle can define a first target duration of approximately (e.g., within 10 percent) 280 seconds and a target temperature gradient defining: a temperature of an inner cavity of the first cook chamber of approximately (e.g., within 10 percent) 345 degrees Fahrenheit; a temperature of an outer cavity of the first cook chamber of approximately (e.g., within 10 percent) 345 degrees Fahrenheit; and a core temperature of approximately 340 degrees Fahrenheit. Finally, upon expiration of the target duration, the brittle outer shell 102 can be removed from the cook chamber for assembly of the multilayer edible carrier 100.

### 5.3 Brittle Outer Shell: Target Characteristics

As described above, the first set of ingredients can be combined in a particular order and at particular concentrations such that, when cooked (e.g., via surface frying), the resulting brittle outer shell 102 exhibits a first set of target characteristics, such as: a crispy texture (e.g., a glassy, brittle, fried-like or brûlée-like texture that shatters when chewed); a particular degree of surface browning (e.g., due to Maillard reactions); a uniform (e.g., smooth, even, consistent) outer surface (e.g., opposite the soft inner shell 104); a finished cook time within a particular brittle-type cook time range (e.g., between 90 seconds and 400 seconds); and/or a quick-release (e.g., with no breakage or sticking) from a brittle-type cook mold when fully cooked.

### 5.3.1 Texture

The brittle-type batter 110 can be configured to generate the brittle outer shell 102 exhibiting a crispy texture (e.g., glassy or fried-like texture), such that when a customer bites into the multilayer edible food carrier 100—including the brittle outer shell 102 and the soft inner shell 104—the brittle outer shell 102 breaks around the customer's bite and shatters in the user's mouth as she chews.

In one implementation, the brittle-type batter no can include a mixture of pregelatinized grain flour and raw grain flour configured to regulate texture and/or rigidity of the resulting brittle outer shell 102. In particular, in this implementation, the brittle outer shell 102 can be configured to exhibit a target texture (e.g., a glassy or fried-like texture). In order to achieve this target texture in the brittle outer shell 102, the brittle-type batter 110 can include an amount of grain flour—including an amount of pregelatinized grain flour and an amount of raw grain flour—defining a ratio of the amount of raw grain flour to the amount of pregelatinized flour corresponding to the target texture of the brittle outer shell 102, such that this ratio can be adjusted to modify the target texture of the brittle outer shell 102.

In one example, the pregelatinized grain flour can be prepared by: mixing an amount of water with an amount of raw grain flour to generate a grain-water mixture; and sous viding this grain-water mixture at a set temperature (e.g., between 170 degrees Fahrenheit and 180 degrees Fahrenheit) for a set duration (e.g., between 90 minutes and 180 minutes) to generate (e.g., via gelatinization of the raw grain flour) the pregelatinized grain flour. The brittle-type batter no can then be mixed (e.g., in a blender) to include a first amount of this pregelatinized grain flour and a second amount of raw grain flour, the first and second amount defining a particular ratio. This particular ratio can be adjusted in order to achieve the “brittle” texture of the brittle outer shell 102.

For example, a first batch of the brittle-type batter no can include a first amount of grain flour including a first amount of pregelatinized grain flour and a second amount of raw grain flour, the first batch of the brittle-type batter no defining a first ratio of the first amount of pregelatinized grain flour to the second amount of raw flour. In this example, a first instance of the brittle outer shell 102—formed of a volume of the first batch of the brittle-type batter no—can be configured to exhibit a first texture characterized by a first brittleness and a first durability. Additionally, in this example, a second batch of the brittle-type batter no can include the first amount of grain flour including a third amount of pregelatinized grain flour and a fourth amount of raw grain flour, the second batch of the brittle-type batter 110 defining a second ratio of the third amount of pregelatinized grain flour to the fourth amount of raw grain flour, such that the second ratio exceeds the first ratio of the first amount of pregelatinized grain flour to the second amount of raw grain flour defined by the first batch of the brittle-type batter 110. In this example, a second instance of the brittle outer shell 102—formed of a volume of the second batch of the brittle-type batter no—can be configured to exhibit a second texture characterized by: a second brittleness, exceeding the first brittleness exhibited by the first instance of the brittle outer shell 102; and a second durability less than the first durability exhibited by the first instance of the brittle outer shell 102.

In one implementation, the brittle-type batter no includes an amount of grain flour including: a first proportion of pregelatinized grain flour (e.g., pregelatinized rice flour)—including raw grain flour and water (e.g., absorbed by the raw grain flour) mixed at a particular ratio of raw flour to water (e.g., one to one)—defining between fifty mass percent and eighty mass percent of the amount of grain flour; and a second proportion of raw grain flour (e.g., raw rice flour) defining between twenty mass percent and fifty mass percent of the amount of grain flour. In one example, the brittle-type batter no includes: the first proportion of pregelatinized grain flour defining between sixty mass percent and seventy mass percent of the amount of grain flour; and a second proportion of raw grain flour defining between thirty mass percent and forty mass percent of the amount of grain flour. In another example, the brittle-type batter no includes: the first proportion of pregelatinized grain flour defining between fifty mass percent and sixty mass percent of the amount of grain flour; and the second proportion of raw grain flour defining between forty mass percent and fifty mass percent of the amount of grain flour.

In this implementation, these proportions can be adjusted to achieve a lighter (e.g., more airy, less dense), crispy texture while maintaining structural integrity of the brittle outer shell 102, such that the brittle outer shell 102 does not (unintentionally) break or fall apart before or during consumption by a customer.

For example, a first batch of the brittle-type batter 110 can include an amount of grain flour including: a first proportion of pregelatinized rice flour of fifty-five mass percent; and a second proportion of raw rice flour of forty-five mass percent. This first batch of the brittle-type batter 110 can be cooked (e.g., according to a brittle-type cook protocol) to generate a first brittle outer shell 102 exhibiting: a first brittleness, characterized by a “light” (e.g., “airy”) structure (e.g., due to lightness of the bubble structure within the brittle-type batter 110), such that when chewed, the first brittle outer shell 102 “shatters” in the customer's mouth; and a first durability, characterized by strength of connections between the inside and outside walls of the first brittle outer shell 102, such that the first brittle outer shell 102 is less susceptible to breakage. Further, in this example, a second batch of the brittle-type batter no can include an amount of grain flour including: a third proportion of pregelatinized rice flour of seventy-five mass percent; and a fourth proportion of raw rice flour of twenty-five mass percent. This second batch of the brittle-type batter no can be cooked (e.g., according to a brittle-type cook protocol) to generate a second brittle outer shell 102 exhibiting: a second brittleness, greater than the first brittleness exhibited by the first brittle outer shell 102, characterized by a “lighter” (e.g., more “airy”) structure such that, when chewed, the second brittle outer shell 102 “shatters” more distinctively in the customer's mouth; and a second durability, less than the first durability exhibited by the first brittle outer shell 102, and characterized by strength of connections between the inside and outside walls of the second brittle outer shell 102 such that the second brittle outer shell 102 is more susceptible to breakage.

Therefore, the brittle-type batter 110 can include both pregelatinized grain flour and raw flour at particular concentrations in the brittle-type batter no in order to achieve a target texture (e.g., a brittle, glassy texture) that is both light (e.g., airy) and durable.

Additionally and/or alternatively, in another implementation, the brittle-type batter no can include an amount of a gas 114 at a particular concentration in order to achieve a target texture defined for the brittle outer shell 102. In particular, the brittle-type batter no can include an amount of gas 114 (e.g., nitrous oxide) injected into the brittle-type batter no, thereby forming a liquid-gas suspension. This amount of gas 114 in the brittle-type batter no can be configured to further regulate texture of the resulting brittle outer shell 102. For example, the amount of gas 114 (e.g., nitrous oxide) can be configured to lighten the brittle-type batter no and cooperate with other ingredients in the brittle-type batter no to form a brittle outer shell 102 exhibiting a “lighter” and/or more “airy” texture.

### 5.3.1 Release

The brittle-type batter 110 can be configured to generate the brittle outer shell 102 exhibiting a quick-release (e.g., without sticking to surfaces of the cook chamber)—defined by no breakage of the brittle outer shell 102 and/or residue from the brittle outer shell 102 remaining in the cook chamber—from the cook chamber when fully cooked.

In particular, proportions of the first set of ingredients can be adjusted to enable a quick-release of the brittle outer shell 102—formed of the cooked brittle-type batter no—from the cook chamber.

For example, the amount of fat mixed into the brittle-type batter 110 can be adjusted to reduce sticking of the brittle outer shell 102 to surfaces of the cook chamber. More specifically, by increasing the amount of fat (e.g., toward a maximum amount of fat), a degree of sticking of the brittle outer shell 102 to surfaces of the cook chamber can be reduced.

Additionally and/or alternatively, in another example, the amount of the release agent can be adjusted to reduce sticking of the brittle outer shell 102 to surfaces of the cook chamber. In this example, by increasing the amount of the release agent, a degree of sticking of the brittle outer shell 102 to surfaces of the cook chamber can be reduced. However, increasing the amount of the release agent may also affect the texture and/or surface finish of the brittle outer shell 102.

In one implementation, the brittle-type batter no can include lecithin (e.g., powdered or liquid lecithin) as the release agent. In this implementation, lecithin can be added to the brittle-type batter no at a particular concentration above a minimum concentration—below which the resulting brittle outer shell 102 exhibits sticking to surfaces of the cook chamber—and below a maximum concentration (e.g., 0.06 percent by weight, 0.12 percent by weight, 0.50 percent by weight)—above which the resulting brittle outer shell 102 exhibits decreased browning, glossiness, and/or uniformity of the surface finish.

Additionally and/or alternatively, in this implementation, in order to maintain the concentration of lecithin below the maximum concentration—and thereby limit reductions in browning, glossiness, and/or uniformity of the surface finish—a volume of oil 116 can be applied to surfaces of the cook chamber to further reduce adhesion (e.g., sticking) of the brittle outer shell 102 to these surfaces upon release. In particular, in this implementation, the brittle-type batter no can include an amount of lecithin configured to: regulate a surface finish of the resulting brittle outer layer, such as an amount of lecithin corresponding to (e.g., configured to yield) a target surface finish defined by the brittle outer layer; and cooperate with an amount of oil 116—applied to surfaces of the cook chamber and absorbed by brittle-type batter 110 loaded within the cook chamber—to regulate release of the brittle outer shell 102 from the cook chamber (e.g., according to a quick-release).

For example, the brittle outer layer can be configured to exhibit a target surface finish—such as characterized by browning and/or uniformity of an outer surface of the brittle outer layer—and a quick-release from the cook chamber. In this example, the brittle-type batter no can include a concentration of lecithin within a concentration range corresponding to both the target surface finish and the quick-release, such that the amount of lecithin cooperates with other ingredients in the brittle-type batter no to enable formation of the brittle outer layer exhibiting the target surface finish and the quick-release from the cook chamber. In one example, a first batch of the brittle-type batter no can be mixed to include a first concentration of lecithin. In this example, a first instance of the brittle outer shell 102—formed of a volume of the first batch of the brittle-type batter no—can thus exhibit: a first surface finish characterized by a first degree of browning and/or a first degree of uniformity; and a first quick-release characterized by a first degree of sticking of the first instance of the brittle outer shell 102 to surfaces of the cook chamber when released from the cook chamber. Further, in this example, a second batch of the brittle-type batter 110 can be mixed to include a second concentration of lecithin exceeding the first concentration of lecithin included in the first batch. In this example, a second instance of the brittle outer shell 102—formed of a volume of the second batch of the brittle-type batter no—can thus exhibit: a second surface finish characterized by a second degree of browning—less than the first degree of browning—and/or a second degree of uniformity less than the first degree of uniformity; and a second quick-release characterized by a second degree of sticking of the second instance of the brittle outer shell 102 to surfaces of the cook chamber when released from the cook chamber, the second degree of sticking less than first degree of sticking exhibited by the first instance of the brittle outer shell 102 formed of the first batch of the brittle-type batter no.

In one variation, the lecithin can be added to the brittle-type batter no within a particular time period offset a start of the cook time (e.g., pouring of the brittle-type batter no into the cook chamber) by a set duration (e.g., 30 minutes, 12 hours, 24 hours, 60 hours). In this variation, the brittle-type batter no can be configured such that the lecithin cooperates with other ingredients in the brittle-type batter no to generate a brittle outer shell 102—exhibiting the target set of characteristics—when the brittle-type batter no is allowed to sit for the set duration (e.g., after mixing) before depositing the brittle-type batter no in the cook chamber. In one example, the brittle-type batter 110 can be prepared (e.g., mixed) at an initial time offset a cook time—corresponding to loading of the brittle-type batter no into the cook chamber—by approximately (e.g., within 5 hours) 48 hours to 60 hours. Alternatively, the brittle-type batter no can be configured to generate the brittle outer shell 102—exhibiting the target set of characteristics—at any time after preparing the brittle-type batter 110.

The brittle-type batter 110 can include the first set of ingredients in particular proportions and/or additional ingredients to achieve this quick-release based on a type of material of surfaces (hereinafter a “cook surface”) of the cooking chamber contacting the brittle-type batter no during cooking within the cooking chamber. For example, the cook surface of the cooking chamber—in contact with the brittle-type batter 110—can be coated with a particular coating or formed of a particular material, such as: a ceramic coating; cast iron; carbon steel; stainless steel; etc.

In one implementation, an amount of oil 116 (e.g., flaxseed oil, canola oil) can be applied to the cook surface at a first target frequency (e.g., once per cook cycle, once every three cook cycles, once every ten cook cycles, once per day, once per week). Additionally and/or alternatively, in this implementation, the cook surface (e.g., a carbon steel surface, a cast iron surface) can be seasoned at a second target frequency to regenerate a coating on the cook surface. For example, an amount of flaxseed oil—in combination with an amount of baking oil (e.g., canola oil and flour)—can be applied to the cook surface prior to each cook cycle for the brittle-type batter no (e.g., prior to loading the brittle-type batter no into the cook chamber). Then, at a regular frequency (e.g., once-per-day, once-per-week, once every 20 cook cycles, once every 100 cook cycles), a coating (e.g., a seasoned iron coating) can be reapplied to the cook surface. Therefore, by applying the amount of oil 116 to the cook surface at a higher frequency than reapplication of the coating to the cook surface, downtime (e.g., due to reapplication of the coating) between cook cycles can be minimized, while minimizing deviation from the target cook time, the target surface finish, and/or the target “quick release” defined for the brittle-type batter 110 and/or the brittle outer shell 102.

### 5.3.1.1 Ceramic Coating

In one implementation, the brittle-type batter no can be configured to cook in a cook chamber with a cook surface coated in a ceramic coating.

In this implementation, the brittle-type batter no can include no release agent and leverage the amount of fat in the brittle-type batter no to enable quick-release of the brittle outer shell 102 from the cook chamber.

Alternatively, in this implementation, the brittle-type batter no can include lecithin as the release agent to enable quick-release of the cooked, brittle outer shell 102 from the cook chamber.

### 5.3.1.2 Cast Iron

In another implementation, the brittle-type batter no can be configured to cook in a cook chamber with a cook surface formed of cast iron material. In this implementation, the brittle-type batter no can include an amount of oil 116 (e.g., flaxseed oil, canola oil)—applied to the cook surface and absorbed by the brittle-type batter no within the cook chamber—as a release agent to enable quick-release of the cooked, brittle outer shell 102 from the cook chamber. In one example, a rag or sponge loaded with a volume of flaxseed oil can be dabbed or brushed across the (interior) cook surface (e.g., contacting the brittle-type batter no) of the cook chamber prior to loading a new volume of the brittle-type batter no into the cook chamber.

Additionally, in one variation, by including oil in the brittle-type batter 110—via absorption from the cook surface—the amount of fat (e.g., ghee) mixed in the brittle-type batter 110 can be reduced. The amount of fat mixed in with the brittle-type batter 110 can thus be leveraged exclusively for flavoring rather than for flavoring and release of the brittle outer shell 102.

Additionally, in this implementation, the brittle-type batter no can include an amount of lecithin—below a threshold concentration of lecithin—configured to cooperate with the amount of oil 116 to enable quick-release of the brittle outer shell 102 from the cook chamber. For example, a first batch of the brittle-type batter no can include a first amount of lecithin; and a second amount of oil 116 absorbed from the cook surface of the cook chamber. When deposited in the cook chamber, the first batch of the brittle-type batter no can generate a first brittle outer shell 102 exhibiting: a first degree of sticking (e.g., characterized by sticking of the brittle outer shell 102 to the cook surface); and a first degree of browning on surfaces of the first brittle outer shell 102. Further, a second batch of the brittle-type batter no can include a second amount of lecithin greater than the first amount of lecithin in the first batch; and (approximately) the second amount of oil 116 absorbed from the cook surface of the cook chamber. When deposited in the cook chamber, the second batch of the brittle-type batter no can generate a second brittle outer shell 102 exhibiting: a second degree of sticking less than the first degree of sticking of the first brittle outer shell 102; and a second degree of browning on surfaces of the second brittle outer shell 102 less than the first degree of browning on surfaces of the first brittle outer shell 102. Therefore, the amount of lecithin included in the brittle-type batter no can be adjusted in order to balance sticking and browning of the resulting brittle outer shell 102.

### 5.3.1.3 Carbon Steel

In one implementation, the brittle-type batter no can be configured to cook in a cook chamber with a cook surface formed of a carbon steel material.

In this implementation, the brittle-type batter 110 can similarly include an amount of oil 116 (e.g., flaxseed oil, canola oil)—applied to the cook surface of the cook chamber—as a release agent for the brittle outer shell 102, as described above. Further, in this implementation, the brittle-type batter no can include an amount of lecithin—below a threshold concentration of lecithin—configured to cooperate with the amount of oil 116 to enable quick-release of the brittle outer shell 102 from the cook chamber, as described above.

### 5.3.2 Cook Time

The brittle-type batter no can be configured to exhibit an outer shell cook time within a target cook time range. In particular, the brittle-type batter no can be configured such that the resulting brittle-type outer shell exhibits the set of target characteristics—corresponding to the brittle, outer shell—after cooking in the brittle-type cook chamber for the outer shell cook time. Further, this target cook time range can include both the outer shell cook time and an inner shell cook time (i.e., a cook time of the soft, inner shell 104), such that both the brittle outer shell 102 and the soft inner shell 104 complete cooking within a threshold duration (e.g., 30 seconds) of the other.

In one implementation, the brittle-type batter no can be configured to exhibit an outer shell cook time approximately (e.g., within 15 seconds, within 30 seconds, within one minute) between 90 seconds and 400 seconds. For example, the brittle-type batter 110 can be configured to exhibit an outer shell cook time of approximately 280 seconds. In one example, the brittle-type batter 110 can be configured to exhibit an outer shell cook time approximately between 180 seconds and 300 seconds. Alternatively, in another example, the brittle-type batter 110 can be configured to exhibit an outer shell cook time approximately between 90 seconds and 150 seconds. In each of these example, amounts of each ingredient in the brittle-type batter no can be adjusted to modify the outer shell cook time.

The brittle-type batter no can include a grain flour mixture of pregelatinized grain flour and raw grain flour configured to regulate the outer shell cook time. In particular, this grain flour mixture can include a first proportion of pregelatinized grain flour and a second proportion of raw grain flour. The first proportion of pregelatinized grain flour can be adjusted to increase and/or decrease the outer shell cook time. For example, a first batch of the brittle-type batter no can include an amount of grain flour including: a first proportion of pregelatinized grain flour of fifty mass percent; and a second proportion of raw rice flour of fifty mass percent. When deposited in the cook chamber, the first batch of the brittle-type batter no can exhibit a first cook time (e.g., between 200 seconds and 300 seconds, between 200 seconds and 400 seconds, greater than 400 seconds). Further, a second batch of the brittle-type batter no can include an amount of grain flour including: a third proportion of pregelatinized grain flour of seventy mass percent; and a fourth proportion of raw rice flour of thirty mass percent. When deposited in the cook chamber, the second batch of the brittle-type batter 110 can exhibit a second cook time (e.g., between 90 seconds and 200 seconds, between 90 seconds and 300 seconds, between 90 seconds and 400 seconds) less than the first cook time. Therefore, these proportions of pregelatinized grain flour and raw grain flour can be adjusted to regulate the brittle-type cook time down to within the target cook time range.

### 5.3.3 Surface Finish

The brittle-type batter 110 can be configured to generate the brittle outer shell 102 exhibiting a target surface finish characterized by uniform, glossy, browned surfaces.

In particular, the first set of ingredients of the brittle-type batter 110 can cooperate to press (e.g., with a minimum force) the brittle-type batter no into surfaces of the cook chamber such that the resulting brittle outer shell 102 exhibits a smooth, uniform surface (e.g., without bumps or graininess). Further, an amount of the release agent (e.g., lecithin) can be adjusted to control browning (e.g., via Maillard Reactions) and glossiness of the resulting brittle outer shell 102.

In one example, the first set of ingredients of the brittle-type batter no can cooperate to form the brittle outer shell 102 exhibiting a smooth surface defining an array of apertures extending into and/or through the brittle outer shell 102. The brittle outer shell 102 can therefore exhibit both a smooth, browned surface (e.g., outer surface) and a light and/or airy texture due to the array of apertures present in the brittle outer shell 102.

### 6. Soft-Type Batter

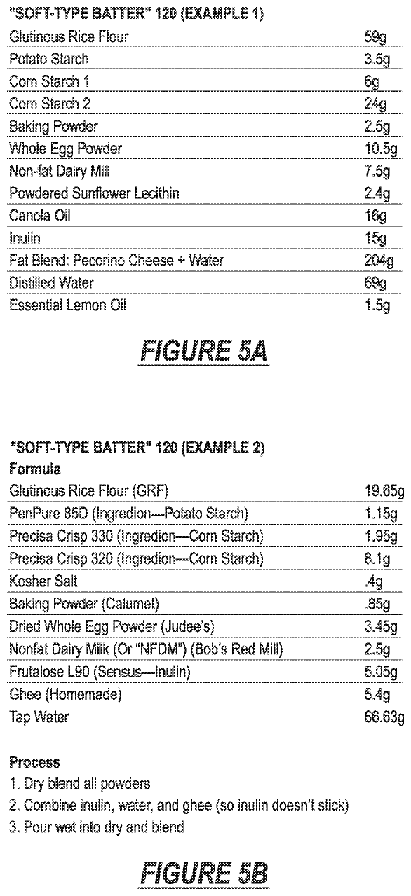

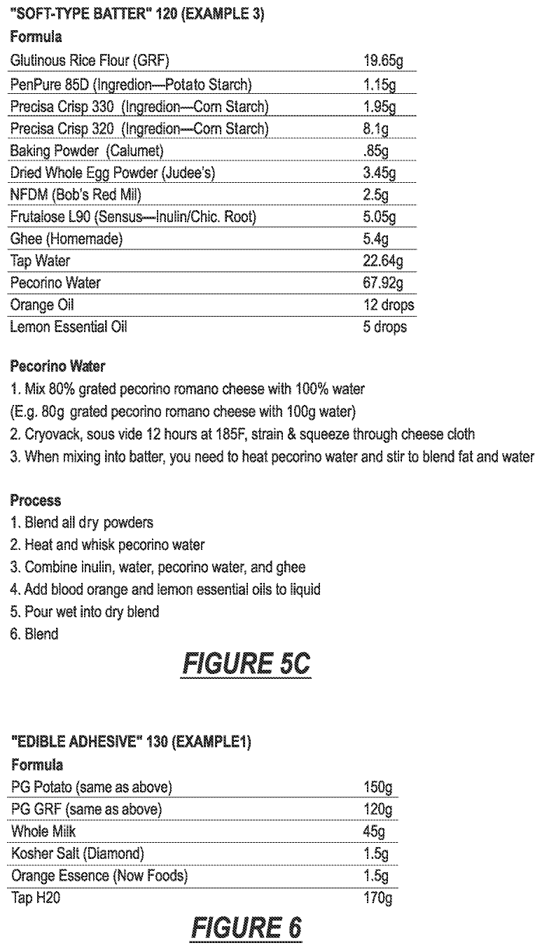

As shown in FIGS. 5A, 5B, and 5C, the soft-type batter 120 can include a second set of ingredients including: water; a fat blend (e.g., a homogenous mixture of cheese and water); grain flour (e.g., glutinous rice flour); starches (e.g., potato starch, corn starch); baking powder, egg products (e.g., egg powder); dairy milk (e.g., nonfat dairy milk); additional fats (e.g., ghee, canola oil); sweeteners and/or prebiotic soluble fibers (e.g., chicory root fiber); and/or flavoring agents (e.g., lemon oil, orange oil).

The second set of ingredients can be combined in a particular order and at particular concentrations such that, when cooked (e.g., via surface frying), the resulting soft inner shell 104 exhibits a second set of target characteristics, such as: a target texture corresponding to a soft texture (e.g., a texture similar to a flexible cracker, mochi, a browned crepe, or undercooked brioche bread when chewed); durability for providing structure to the multilayer edible food carrier 100 and supporting the brittle outer shell 102; a particular flavor profile, such as based on a type of filling (e.g., food) loaded within the multilayer edible food carrier 100 when assembled; a particular degree of surface browning (e.g., due to Maillard reactions); a uniform (e.g., smooth, even, consistent) outer surface (e.g., opposite the soft inner shell 104); a finished cook time within a particular cook time range (e.g., between 90 seconds and 400 seconds); a finished cook time within a soft-type cook time range (e.g., between 60 seconds and 400 seconds) approximating the brittle-type cook time range (e.g., within 30 seconds, within 90 seconds) such that the resulting soft inner shell 104 and brittle outer shell 102 can be immediately combined to form the multilayer edible food carrier 100; and/or a quick-release (e.g., with no breakage or sticking) from a soft-type cook mold when fully cooked.

In one implementation, the soft inner shell exhibits a finished cook time within a soft-type cook time range between 90 seconds and 150 seconds (e.g., 90 seconds, 115 seconds, 150 seconds). Alternatively, in another implementation, the soft inner shell exhibits a finished cook time within a soft-type cook time range exceeding 150 seconds (e.g., between 150 seconds and 400 seconds), such that the increased cook time results in a soft inner shell 104 exhibiting a relatively greater wall thickness.

In one implementation, as shown in FIGS. 5A-5C, the soft-type batter 120 can include: an amount of grain flour, such as a mixture of pregelatinized grain flour and raw grain four; an amount of starches (e.g., potato starches and/or corn starches); an amount of baking powder; an amount of an emulsifier (e.g., whole egg powder); an amount of non-fat dairy milk; an amount of lecithin (e.g., powdered sunflower lecithin); and amount of oil 116 (e.g., canola oil); an amount of sweeteners (e.g., inulin); an amount of a fat blend, such as including a mixture of cheese and water; an amount of water (e.g., distilled water); and/or an amount of flavorings (e.g., lemon oil, orange oil, salt).

In this implementation, the soft-type batter 120 can be generated during a second preparation period, such as concurrent and/or within a threshold duration of the first preparation period for the brittle-type batter 110. In particular, during the second preparation period: a second set of ingredients—such as including an amount of water, an amount of grain flour, an amount of starches, an amount of baking powder, an amount of an emulsifier, an amount of non-fat dairy milk, an amount of lecithin, an amount of fats (e.g., oil), an amount of sweeteners, an amount of a fat blend, and/or an amount of flavorings—can be mixed in a particular order and at particular concentrations to generate the soft-type batter 120.

In this implementation, the fat-blend can be generated by: mixing a first amount of cheese (e.g., pecorino cheese) with a second amount of water (e.g., tap or distilled water) to generate a cheese-water mixture, such as at a ratio of the first amount of cheese to the first amount of water of approximately (e.g., within 10 percent) 80 to 100; and sous-viding the cheese-water mixture for a set duration (e.g., 12 hours) at a set temperature (e.g., 185 degrees Fahrenheit) to generate an amount of the fat-blend. Additionally, this fat-blend can be strained—such as via a cheesecloth—after sous-viding the mixture. Then, the amount of water, the amount of grain flour, the amount of starches, the amount of baking powder, the amount of the emulsifier, the amount of non-fat dairy milk, the amount of lecithin, the amount of fats (e.g., oil), amount of sweeteners, and the amount of flavorings can be mixed to generate a first mixture. The fat blend can then be mixed into this first mixture to generate the soft-type batter 120.

Then, during a second cook period for the soft inner shell 104, a volume of the soft-type batter 120 can be loaded into a second cook chamber—configured to transform volumes of the soft-type batter 120 into instances of the soft inner shell 104—and cooked according to a second cook cycle defining a second target duration (e.g., between 90 seconds and 400 seconds)—defined for the soft inner shell 104—to transform the volume of the soft-type batter 120 into the soft inner shell 104. In response to expiration of the second target duration, the soft inner shell 104 can be removed from the second cook chamber.

In one implementation, the soft-type batter 120 can be cooked within the second cook chamber for a target duration corresponding to a target wall thickness of the resulting inner soft shell. For example, a first batch of the soft-type batter 120 can be cooked within the second cook chamber for a first duration (e.g., between 90 seconds and 400 seconds) to form a first instance of the inner soft shell exhibiting a first wall thickness. In this example, a second batch of the soft-type batter 120 can be cooked within the second cook chamber for a second duration (e.g., exceeding 400 seconds) to form a second instance of the inner soft shell exhibiting a second wall thickness exceeding the first wall thickness. Additionally and/or alternatively, in this implementation, the soft-type batter 120 can be cooked within the second cook chamber for a second target duration falling within a threshold duration of a first target duration defined for cooking of the brittle-type batter no.

### 6.4 Example: Soft-Type Batter

In one example, the soft-type batter 120 includes a second set of ingredients including: a fat blend including a first volume of water (e.g., 25 percent of the fat blend by weight) and an amount of cheese (e.g., 75 percent of the fat blend by weight) mixed with the first volume of water; an amount of glutinous rice flour; an amount of starches including a potato starch, a corn starch, and/or a native food starch; an amount of baking powder; an amount of egg powder (i.e., an emulsifier) including a concentration of lecithin configured to enable quick-release of the resulting soft inner shell 104 from the cook chamber; an amount of dairy milk (e.g., nonfat dairy milk); an amount of ghee; and a volume of water. In this example, the soft-type batter 120 can include a set of flavorings—such as lemon oil (e.g., infused in the ghee), orange oil, adobo, etc.—configured to impart a particular flavor into the resulting soft inner shell 104. Additionally, the soft-type batter 120 can also include an amount of sweeteners and/or prebiotic soluble fibers (e.g., sugar, oligofructose)—such as chicory root fiber (e.g., in liquid form)—to increase browning of the soft-type batter 120 during cooking.

Additionally and/or alternatively, in another example, the soft-type batter 120 can include an amount of pregelatinized rice flour configured to regulate texture and/or surface finish (e.g., uniformness, smoothness, browning) of the resulting soft inner shell 104. In this example, the amount of starches can be reduced or omitted from the soft-type batter 120.

In each of these examples, a volume of this soft-type batter 120 can be deposited within the cook chamber to generate the soft inner shell 104. During cooking, the second set of ingredients can cooperate to expand within the cook chamber, thereby pressing the soft-type batter 120 against the interior walls of the cook chamber and forming (e.g., via baking in the cook chamber) smooth surfaces of the resulting soft inner shell 104. The soft-type batter 120 can thus generate a soft inner shell 104: exhibiting smooth, browned surfaces; defining a target texture gradient defined by a soft (e.g., “doughy”) interior texture and crust-like surfaces; and that may be easily removed (e.g., without sticking) from the cook chamber—with no tears in the soft inner shell 104 or food residue from the soft inner shell 104 remaining in the cook chamber—at an outer shell cook time of approximately 90 seconds (e.g., within 10 seconds) and within the target cook time range.

### 7. Adhesive Coating

In one variation, the multilayer edible food carrier 100 can include an edible adhesive layer 130 (hereinafter an “edible adhesive” 130) configured to retain an inner surface of the brittle outer shell 102 against an outer surface of the soft inner shell 104. In particular, the multilayer edible food carrier 100 can include a volume of the edible adhesive 130—applied to the outer surface of the soft inner shell 104 in a preassembled configuration (e.g., upon removing the soft inner shell 104 from the cook chamber and prior to loading the soft inner shell 104 within the brittle outer shell 102)—configured to promote adhesion between the outer surface of the soft inner shell 104 and an inner surface of the brittle outer shell 102 in the assembled configuration.

In one implementation, the edible adhesive 130 can include a homogenous mixture of water, starch, grain flour, salt, milk, and flavorings. For example, the edible adhesive 130 can include: an amount of water (e.g., tap and/or distilled water), an amount of a potato blend (e.g., pregelatinized potato), such as including a mixture of water and potato (e.g., potato flakes)—mixed at a particular ratio of water to potato (e.g., approximately two to one)—sous vided at a set temperature (e.g., 180 degrees Fahrenheit) between 170 degrees Fahrenheit and 200 degrees Fahrenheit and for a set duration (e.g., 90 minutes) between 60 minutes and 120 minutes; an amount of pregelatinized grain flour (e.g., pregelatinized rice flour), such as prepared according the methods and techniques described above; an amount of whole milk; an amount of kosher salt; and/or an amount of orange essence, lemon oil, and/or any other flavoring. These ingredients can thus be mixed to form an adhesive (or “paste”) that can be applied to an outer surface of the soft inner shell 104—formed of the soft-type batter 120—prior to inserting the soft inner shell 104 into the brittle outer shell 102 to form the multilayer edible food carrier 100.

In one example, the edible adhesive 130 can include: a first amount of pregelatinized potato (e.g., between twenty-five percent and thirty-five percent by weight); a second amount of pregelatinized rice flour (e.g., between twenty percent and thirty percent by weight); a third amount of whole milk (e.g., between five percent and fifteen percent by weight); a fourth amount of kosher salt (e.g., between zero percent and one percent by weight); a fifth amount of orange flavoring (e.g., zero percent and one percent by weight); and a sixth amount of water (e.g., between thirty percent and forty percent by weight).

### 8. Fillings

Once the multilayer edible carrier 100 is assembled, the operator may load various fillings 140 and toppings into the internal volume formed by the multilayer edible carrier 100, such as salad fillings, taco fillings, meatball marinara fillings, or any other sweet and/or savory fillings, as shown in FIGS. 1, 2B, and 3. With the multilayer edible carrier 100 loaded with an edible filling (hereinafter a “filling”), the soft inner shell 104 of the edible carrier 100 can function as a barrier between liquids in the filling and the brittle outer shell 102 (e.g., by absorbing this liquid or preventing diffusion of this liquid toward the brittle outer shell 102), thereby: preventing absorption of these liquids by the brittle outer shell 102; preventing softening of the brittle outer layer; maintaining the “crispy” or “crunchy” mouthfeel of the edible carrier 100 over an extended duration of time (e.g., throughout the entire duration of a meal); and extend a shelf life of the multilayer edible carrier 100, such as from ordering of a meal including the multilayer edible carrier 100 by a patron, through delivery of the meal to the patron (e.g., at a restaurant and/or at the patron's home), and through consumption of the meal by the patron.

In one implementation, the multilayer edible carrier 100 can include a set of fillings 140 loaded within the internal volume—formed by the multilayer edible carrier 100—corresponding to a food product type. For example, the multilayer edible carrier 100 can be loaded with: a first set of fillings 140 corresponding to taco fillings; a second set of fillings 140 corresponding to salad fillings; or a third set of fillings 140 corresponding to pasta fillings. However, the multilayer edible carrier 100 can be loaded with any type of fillings 140 to generate a foodstuff (e.g., an edible foodstuff) formed of the brittle outer shell 102, the soft inner shell 104, and the set of edible fillings 140 loaded within the internal volume defined by the multilayer edible carrier 100.

Additionally and/or alternatively, in another implementation, the soft-type batter 120 can be configured to include an amount of flavorings corresponding to the food product type. Therefore, in this implementation, the soft-type batter 120—and therefore the resulting cooked, soft inner shell 104—can be configured to exhibit a target flavor profile corresponding to the food product type. For example, a first instance of the multilayer edible carrier 100 can be loaded with a first set of taco fillings corresponding to a taco-adjacent food product. In this example, the soft-type batter 120 can include an amount of flavorings—such as including cumin, chili powder, and/or other seasonings associated with the taco-adjacent food product—configured to regulate a flavor profile of the soft-type batter 120 and therefore the soft inner shell 104.

As a person skilled in the art will recognize from the previous detailed description and from the figures and claims, modifications and changes can be made to the embodiments of the invention without departing from the scope of this invention as defined in the following claims.

I claim:

1. An edible food carrier comprising:
a brittle edible layer formed of a first batter comprising:
a volume of a base mixture comprising:
an amount of water;
an amount of salt;
an amount of potato;
an amount of grain flour defining a ratio of pregelatinized flour to raw flour corresponding to a target texture defined for the brittle edible layer;
an amount of fat corresponding to a target flavor profile defined for the brittle edible layer; and
an amount of lecithin defining a concentration within a target concentration range corresponding to a target surface finish defined for the brittle edible layer;
a volume of gas dispersed throughout the base mixture and configured to cooperate with the base mixture to form a liquid-gas suspension; and
an amount of oil:
absorbed by the liquid-gas suspension within a cook chamber configured to transform the first batter into the brittle edible layer; and
configured to cooperate with the fifth amount of lecithin to regulate release of the brittle edible layer from the cook chamber; and
soft edible layer:
nested within the brittle edible layer in an assembled configuration; and
formed of a second batter comprising water, a fat blend comprising cheese dissolved in water, an amount of grain flour, an amount of starches, an amount of baking powder, an amount of an emulsifying agent, an amount of dairy milk, an amount of fat, an amount of sweeteners, and an amount of flavoring agents.

2. The edible food carrier of claim 1, further comprising an edible adhesive:
applied to an outer surface of the soft edible layer in a preassembled configuration;
configured to promote adhesion between the outer surface of the soft edible layer and an inner surface of the brittle edible layer in the assembled configuration; and
comprising a homogenous mixture of water, starch, grain flour, salt, milk, and flavorings.

3. The edible food carrier of claim 1:
further comprising a set of edible fillings loaded within an internal volume formed by the brittle edible layer and the soft edible layer in the assembled configuration; and
wherein the brittle edible layer, the soft edible layer, and the set of edible fillings cooperate to define a foodstuff.

4. The edible food carrier of claim 3:
wherein the set of edible fillings loaded within the internal volume comprises the set of edible fillings loaded within the internal volume and corresponding to a food product type; and
wherein the soft edible layer is:
configured to exhibit a flavor profile corresponding to the food product type; and
formed of the second batter comprising flavoring agents corresponding to the flavor profile.

5. The edible food carrier of claim 1:
wherein the brittle edible layer is configured to exhibit a target texture;
wherein the amount of grain flour comprises an amount of pregelatinized grain flour and an amount of raw grain flour; and
wherein the first batter defines a ratio of the amount of raw grain flour to the amount of pregelatinized flour corresponding to the target texture of the brittle edible layer.

6. The edible food carrier of claim 5:
wherein a first batch of the first batter:
comprises a first amount of grain flour comprising a first amount of pregelatinized grain flour and a second amount of raw grain flour; and
defines a first ratio of the first amount of pregelatinized grain flour to the second amount of raw flour;
wherein a first instance of the brittle edible layer, formed of the first batch of the first batter, exhibits a first texture characterized by a first brittleness and a first durability;
wherein a second batch of the first batter:
comprises the first amount of grain flour comprising a third amount of pregelatinized grain flour and a fourth amount of raw grain flour; and
defines a second ratio of the third amount of pregelatinized grain flour to the fourth amount of raw flour, the second ratio exceeding the first ratio; and
wherein a second instance of the brittle edible layer, formed of the second batch of the first batter, exhibits a second texture characterized by a second brittleness, exceeding the first brittleness, and a second durability less than the first durability.

7. The edible food carrier of claim 1:
wherein the amount of water comprises an amount of distilled water;
wherein the amount of lecithin comprises an amount of sunflower lecithin;
wherein the amount of potato comprises an amount of pregelatinized potato;
wherein the amount of grain flour comprises an amount of glutinous rice flour;
wherein the amount of fat comprises an amount of ghee; and
wherein the volume of gas comprises a volume of nitrous oxide.

8. The edible food carrier of claim 7:
wherein the brittle edible layer is configured to exhibit a first target cook time within the first cook chamber and a target texture characterized by a first degree of brittleness;
wherein the amount of fat, the amount of lecithin, and the amount of pregelatinized grain flour cooperate to regulate the first target cook time; and
wherein the soft edible layer is configured to exhibit:
a second target cook time within a threshold deviation of the first target cook time; and
a second target texture distinct from the first target texture characterized by a second degree of brittleness less than first degree of brittleness.

9. The edible food carrier of claim 1, wherein the base mixture comprises:
the amount of water exhibiting a first concentration between 35 percent and 45 percent by weight;
the amount of salt defining a second concentration between 0.20 percent and 1 percent by weight;
the amount of grain flour comprising:
a first amount of raw grain flour defining a third concentration between 5 percent and 15 percent by weight; and
a second amount of pregelatinized grain flour defining a fourth concentration between 5 percent and 20 percent by weight, the second amount of pregelatinized grain flour formed via sous viding a mixture of distilled water and raw grain flour for a set duration at a set temperature;
the amount of lecithin defining a fifth concentration between zero percent and 0.40 percent by weight; and
the amount of fat defining a sixth concentration between 5 percent and 15 percent by weight; and
the amount of potato defining a seventh concentration between 20 percent and 30 percent by weight.

10. The edible food carrier of claim 1:
wherein the brittle edible layer is configured to exhibit a target surface finish and a quick-release when released from the cook chamber;
wherein the first batter comprises a concentration of lecithin within a concentration range corresponding to the target surface finish and the quick-release; and
wherein the amount of oil is configured to cooperate with the amount of lecithin to regulate release of the brittle edible layer from the cook chamber according to the quick-release.

11. The edible food carrier of claim 10:
wherein a first batch of the first batter comprises a first concentration of lecithin;
wherein a first instance of the brittle edible layer, formed of the first batch of the first batter, exhibits:
a first surface finish characterized by a first degree of browning; and
a first quick-release characterized by a second degree of sticking of the first instance of the brittle edible layer to surfaces of the cook chamber when released from the cook chamber;
wherein a second batch of the first batter comprises a second concentration of lecithin exceeding the first concentration of lecithin; and
wherein a second instance of the brittle edible layer, formed of the second batch of the first batter, exhibits:
a second surface finish characterized by a third degree of browning less than the first degree of browning; and
a second quick-release characterized by a fourth degree of sticking of the second instance of the brittle edible layer to surfaces of the cook chamber when released from the cook chamber, the fourth degree of sticking less than the second degree of sticking.

12. The edible food carrier of claim 1:
wherein the brittle edible layer formed of the first batter comprises the brittle edible layer formed via cooking of a volume of the first batter within the cook chamber according to a first cook cycle defining:
a first target temperature between 300 degrees Fahrenheit and 400 degrees Fahrenheit; and
a first target duration between 90 seconds and 400 seconds; and
wherein the soft edible layer formed of the second batter comprises the soft edible layer formed via cooking of a volume of the second batter within a second cook chamber, configured to transform the second batter into the soft edible layer, according to a second cook cycle defining:
a second target temperature between 280 degrees Fahrenheit and 375 degrees Fahrenheit; and
a second target duration between 90 seconds and 400 seconds.

13. An edible food carrier comprising:
a brittle edible layer:
configured to exhibit a first target texture and a first target cook time; and
formed of a first batter cooked within a first cook chamber to form the brittle edible layer and comprising:
an amount of water;
an amount of salt;
an amount of grain flour;
an amount of potato;
an amount of fat;
an amount of a release agent; and
an amount of nitrous oxide;
a soft edible layer:
configured to:
exhibit a second target texture distinct from the first target texture;
exhibit a second target cook time within a threshold deviation of the first target cook time;
exhibit a target flavor profile; and
nest within the brittle edible layer in an assembled configuration to form an inner volume configured to receive a set of edible fillings; and
formed of a second batter cooked within a second cook chamber to form the soft edible layer, the second batter comprising water, fat, grain flour, starches, baking powder, an emulsifying agent, dairy milk, sweeteners, and flavoring agents.

14. A method comprising:
during a first preparation period:
mixing a first set of ingredients to generate a base mixture, the first set of ingredients comprising a first amount of water, a first amount of salt, a first amount of grain flour, a first amount of potato, a first amount of fats, and a first amount of lecithin; and
pressurizing the base mixture with a volume of nitrous oxide to generate a first batter comprising a liquid-gas suspension of nitrous oxide dispersed throughout the base mixture;
during a first cook period succeeding the first preparation period:
applying oil to surfaces of a first cook chamber;
loading a volume of the first batter into the first cook chamber;
cooking the volume of the first batter within the first cook chamber, according to a first cook cycle of a first target duration, to transform the volume of the first batter into a brittle edible layer; and
in response to expiration of the first target duration, removing the brittle edible layer from the second cook chamber;
during a second preparation period, mixing a second set of ingredients to generate a second batter, the second set of ingredients comprising a second amount of water, a second amount of fats, a second amount of grain flour, an amount of starches, an amount of baking powder, an amount of an emulsifying agent, an amount of sweeteners, and an amount of flavoring agents;
during a second cook period succeeding the second preparation period:
loading a volume of the second batter into a second cook chamber;
cooking the volume of the second batter within the second cook chamber, according to a second cook cycle of a second target duration, to transform the volume of the second batter into a soft edible layer; and
in response to expiration of the second target duration, removing the soft edible layer from the second cook chamber; and
during an assembly period succeeding the first cook period and the second cook period, nesting the soft edible layer within the brittle edible layer to form a multilayer edible carrier configured for loading with edible fillings.

15. The method of claim 14:
further comprising, during the assembly period, loading a set of fillings into the multilayer edible carrier to assemble a foodstuff; and
wherein nesting the soft edible layer within the brittle edible layer to form the multilayer edible carrier configured for loading with edible fillings comprises nesting the soft edible layer within the brittle edible layer to form the multilayer edible carrier configured for loading with set of edible fillings, the soft edible layer configured to prevent diffusion of liquid from the set of fillings toward the brittle edible layer.

16. The method of claim 14:
further comprising, during the assembly period, applying an edible adhesive to an outer surface of the soft edible layer, the edible adhesive configured to promote adhesion between the outer surface of the soft edible layer and an inner surface of the brittle edible layer; and
wherein nesting the soft edible layer within the brittle edible layer comprises nesting the soft edible layer, comprising the edible adhesive applied to the outer surface, within the brittle edible layer.

17. The method of claim 16, wherein applying the edible adhesive to the outer surface of the soft edible layer comprises applying the edible adhesive to the outer surface of the soft edible layer, the edible adhesive comprising water, starches, grain flour, milk, salt, and flavorings.

18. The method of claim 14:
wherein mixing the first set of ingredients to generate the base mixture comprises:
mixing an amount of water with an amount of raw grain flour to generate a grain-water mixture;
sous viding the grain-water mixture at a set temperature, between 170 degrees-Fahrenheit and 190 degrees-Fahrenheit, and for a set duration, between 60 minutes and 120 minutes, to generate a pregelatinized grain flour; and
mixing the first amount of water, the first amount of salt, the first amount of grain flour comprising a first amount of the pregelatinized grain flour and a second amount of raw grain flour, the first amount of potato, the first amount of fat, and the first amount of lecithin to generate the base mixture defining a target ratio of the first amount of the pregelatinized grain flour to the second amount of raw grain flour between 1.0 and 2.0; and
wherein applying oil to surfaces of the first cook chamber comprises applying an amount of oil to surfaces of the first cook chamber, the amount of oil corresponding to the target ratio and configured to cooperate with the first amount of the pregelatinized grain flour to regulate release of the brittle edible layer from the first cook chamber.

19. The method of claim 14:
wherein pressurizing the base mixture with the volume of nitrous oxide to generate the first batter comprises:
loading the base mixture into a whipping siphon; and
within the whipping siphon, pressurizing the base mixture with the volume of nitrous oxide to generate the first batter; and
wherein loading the volume of the first batter into the first cook chamber comprises injecting the volume of the first batter at room temperature, from the whipping siphon, into the first cook chamber.

20. The method of claim 14:
wherein cooking the volume of the first batter within the first cook chamber according to the first cook cycle of the first target duration comprises cooking the volume of the first batter within the first cook chamber according to the first cook cycle defining:
the first target duration between 90 seconds and 400 seconds; and
a first target temperature between 300 degrees Fahrenheit and 400 degrees Fahrenheit; and
wherein cooking the volume of the second batter within the second cook chamber according to the second cook cycle of the second target duration comprises cooking the volume of the second batter within the second cook chamber according to the second cook cycle defining:
the second target duration between 90 seconds and 400 seconds; and
a first target temperature between 280 degrees Fahrenheit and 375 degrees Fahrenheit.
